(19) United States
(12) Patent Application Publication
(10) Pub. No.: US 2006/0180260 A1
(43) Pub. Date: Aug. 17, 2006

(54) RACING PNEUMATIC TIRE

(76) Inventor: Tatsuya KATO, Osaka-shi, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/382,087

(22) Filed: May 8, 2006

(30) Foreign Application Priority Data
May 9, 2005 (JP) 2005-135883

(51) Int. Cl. B60C 9/02

(52) U.S. Cl. 152/548; 152/558; 152/562

(57) ABSTRACT

Two carcass layers for reinforcing between a pair of annular beads are laminated such that cords are inclined substantially symmetrically with respect to the tire circumferential direction, an angle of the cords with respect to the tire circumferential direction in a region of 10% of a belt width from a widthwise end of the belt layer toward a tire equator is 40 to 80°, and an angle of the cords with respect to the tire circumferential direction in the vicinity of the tire equator and in the vicinity of the maximum width position is greater than the angle in the region by 5° and is 75° or greater.

### BACKGROUND OF THE INVENTION 1. Field of the Invention

The present invention relates to a racing pneumatic tire mounted on a racing vehicle such as a formula car.

2. Description of the Related Art

A racing pneumatic tire (racing tire) used for a circuit is required to have excellent cornering performance and traction performance. Therefore, it is necessary for the racing pneumatic tire to secure a ground-contact area at a tread portion when high lateral gravity or driving force is applied. Hence, there is a conventionally known technique for reinforcing a tire by a bias structure in which two or more carcass layers are laminated such that cords intersect with in a tire circumferential direction substantially symmetrically.

For example, the following Japanese Patent Application Laid-open No. H6-227209 discloses a racing pneumatic tire in which two carcass layers are laminated such that cords intersect with the tire circumferential direction substantially symmetrically at an angle of 56 to 86°. According to this structure, lateral rigidity and longitudinal rigidity of the tire are increased, the ground-contact area of the tread portion is secured, and the cornering performance and traction performance are enhanced. However, in such a case, not only the lateral rigidity and longitudinal rigidity of the tire, but also vertical rigidity is increased and thus, there are problems as follows. That is, if the vertical rigidity of the tire is increased, this reduces the ground-contact area of the tread portion, and when the 5 vehicle is a racing vehicle such as a formula car, since the weight of the vehicle is lighter than a general passenger vehicle, the vehicle is prone to jump, adhesion is deteriorated and running time is increased (becomes slower).

The following Japanese Patent Application Laid-open 10 No. S61-263805, Japanese Patent Application Laid-open No. 2001-138707, Japanese Patent Application Laid-open No. 2002-127711 and Japanese Patent Application Laid-open No. 2002-274121 disclose techniques in which a carcass layer of a pneumatic tire of a general passenger vehicle, angle of cords is varied depending upon a location of the tire. However, even if the vertical rigidity of the pneumatic tire for the passenger vehicle is suppressed, only the riding comfort is improved, and this does not satisfy the severe requirement to shorten the running time during the racing.

That is, any of the publications does not disclose a useful structure for shortening the running time in the racing pneumatic tire.

### SUMMARY OF THE INVENTION

The present invention has been accomplished in view of the above circumstances, and it is an object of the invention to provide a racing pneumatic tire capable of increasing lateral rigidity and longitudinal rigidity to shorten running time while suppressing increase in vertical rigidity of the tire.

The object can be achieved by the present invention having the following structure. That is, the present invention provides a racing pneumatic tire comprising at least two carcass layers for reinforcing between a pair of annular beads, and a belt layer disposed on an outer peripheral side of the carcass layer below a tread portion, wherein the two carcass layers are laminated on each other such that cords are inclined substantially symmetrically with respect to a tire circumferential direction, an angle of the cords with respect to the tire circumferential direction in a first region of 10% of a belt width from a widthwise end of the belt layer toward a tire equator is 40 to 80°, and an angle of the cords with respect to the tire circumferential direction in the vicinity of the tire equator and in the vicinity of the maximum width position is greater than the angle in the first region by 5° and is 75° or greater.

According to this structure, in the first region, the cords of the two carcass layers intersect with the tire circumferential direction substantially symmetrically at the angle of 40 to 80°. Therefore, a bias structure is formed in the vicinity of the shoulder portion, the lateral rigidity and longitudinal rigidity of the tire are increased, and a ground-contact area can be secured at the tread portion. Further, the angle of the cords with respect to the tire circumferential direction near the tire equator and tire maximum width position is greater than that of the first region by 5° or more and is 75° or greater. With this, it is possible to prevent the vertical rigidity of the tire from increasing. The angle of the cords constituting the carcass layer of the invention is a value when an air pressure of 120 kPa is charged into the tire.

In the racing pneumatic tire, it is preferable that the angle of the cords with respect to the tire circumferential direction in a second region of 10% of a belt width from the widthwise end of the belt layer toward the tire maximum width position is 40 to 80°, and the angle of the cords with respect to the tire circumferential direction in the vicinity of the tire equator and in the vicinity of the maximum width position is greater than the angle in the second region by 50 and is 75° or greater. With this structure, the lateral rigidity and longitudinal rigidity of the tire can be enhanced more preferably, and the running time of the racing pneumatic tire can be shortened effectively.

In the racing pneumatic tire, it is preferable that the angle of the cords with respect to the tire circumferential direction in the second region is greater than that in the first region by 10 to 20°. In the second region where influence on the vertical rigidity is greater than that of the first region, the angle of the cords with respect to the tire circumferential direction is set relatively great, it is possible to effectively suppress the increase of vertical rigidity of the tire.

### Brief Description of the Drawings

FIG. 1 is a semi-sectional view of a meridian showing one example of a racing pneumatic tire according to the present invention;

FIGS. 2 shows an essential portion of the racing pneumatic tire of the invention, wherein (a) is a partially cut-away front view of the tire and (b) is a plan view thereof;

FIGS. 3 show one example of carcass ply according to the present invention, wherein (a) is a plan view of a ply for a lower layer and (b) is a plan view of a ply for an upper layer; and

FIG. 4 is a schematic perspective view of an apparatus for producing the carcass ply.

### DESCRIPTION OF THE PREFERRED EMBODIMENT

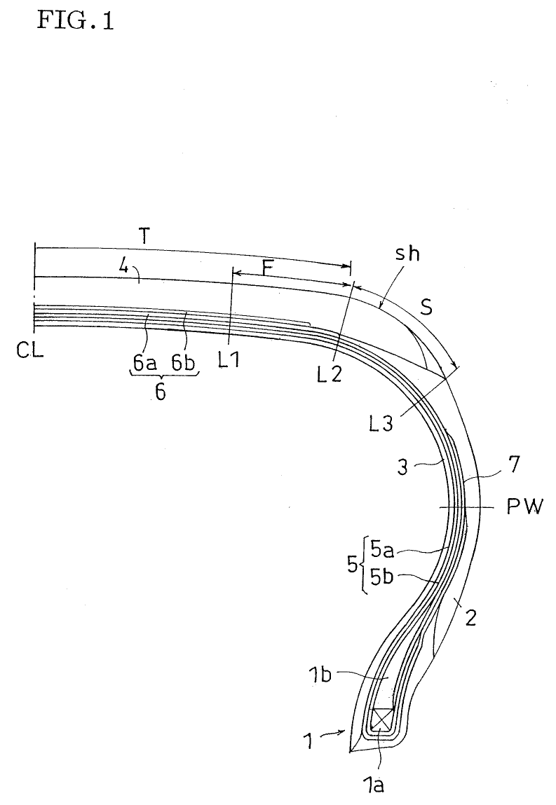

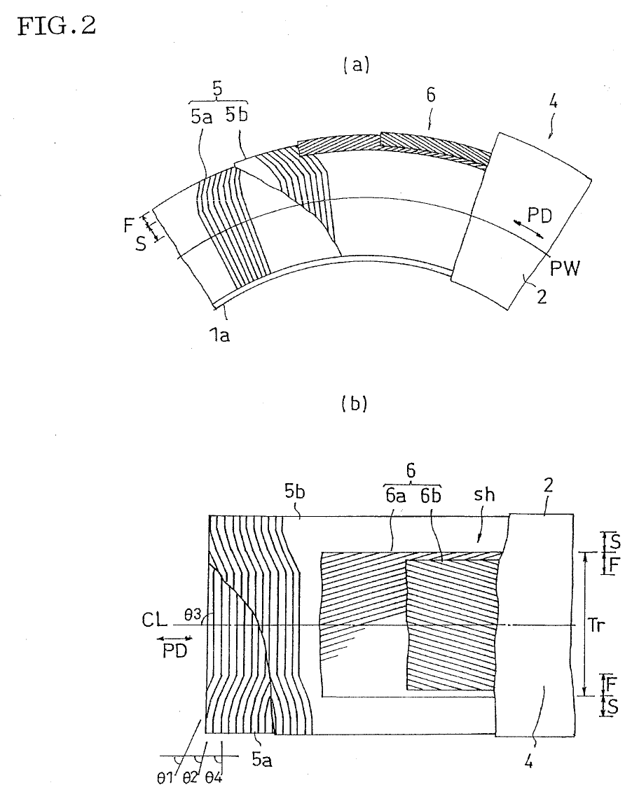

An embodiment of the present invention will be explained with reference to the drawings. FIG. 1 is a semi-sectional view of a meridian showing one example of a racing pneumatic tire according to the present invention. FIG. 2(a) is a partially cut-away front view of the tire and FIG. 2(b) is a plan view thereof.

As shown in FIG. 1, the racing pneumatic tire of the present invention includes at least two carcass layers 5 for reinforcing between a pair of annular beads la, and a belt layer 6 disposed on the outer peripheral side of the carcass layers 5 below a tread portion Tr.

This embodiment has the two carcass layers 5. As shown in FIG. 2, the two carcass layers 5a and 5b are laminated such that cords are inclined substantially symmetrically with respect to a tire circumferential direction PD. Examples of material of the cords constituting the carcass layers 5 are organic fibers such as polyester, polyamide and polyaramid, and steel.

Both ends of each of the carcass layers 5 are folded back outward at the bead 1a. A bead filler 1b made of hard rubber is disposed between the folded back portion and a main body portion, thereby forming the bead portion 1. Like a normal tire, a sidewall rubber 2, an inner liner rubber 3, a tread rubber 4 and the like are disposed outside of the carcass layer 5. Examples of raw material rubbers for these are natural rubber, styrene-butadiene rubber (SBR), butadiene rubber (BR), isoprene rubber (IR), butyl rubber (IIR) and the like. These rubbers are used alone or a combination thereof. These rubbers are reinforced using filler such as carbon black and silica, and cure, accelerator, plasticizer, antioxidant or the like is appropriately mixed.

In this embodiment, the belt layer 6 comprises two layers, i.e., an inner layer 6a and an outer layer 6b. The inner layer 6a and the outer layer 6b are laminated such that cords intersect substantially symmetrically with the tire circumferential direction PD at an angle of 20 to 50°. Examples of material of the cords constituting the belt layer 6 are organic fibers such as polyester, polyamide and polyaramid, and steel.

Cords constituting the carcass layers 5a and 5b also are disposed such as to intersect substantially symmetrically with the tire circumferential direction PD at an angle of θ1 in a region F (corresponding to the first region) of 10% of a belt width from an end of the belt layer 6 in the widthwise direction toward the tire equator CL. The angle θ1 is set to 40 to 80°, and preferably 40 to 60°. With this, a bias structure is formed in the vicinity of a shoulder portion sh, the lateral rigidity and longitudinal rigidity of the tire are enhanced, and a ground-contact area can be secured at the tread portion Tr.

In this embodiment, the cords constituting the carcass layers 5a and 5b are disposed such as to intersect with the tire circumferential direction PD at an angle θ2 in a region S (corresponding to the second region) of 10% of a belt width from the end of the belt layer 6 in the widthwise direction toward the tire maximum width position PW along the shape of the carcass. The angle θ2 is set to 40 to 80°, and more preferably 50 to 70°. With this, the lateral rigidity and longitudinal rigidity of the tire are enhanced, and the ground-contact area can effectively be secured at the tread portion Tr.

If the angles θ1 and θ2 exceed 80°, the tire reinforcing effect becomes small, and it becomes difficult to secure the ground-contact area of the tread portion Tr. If the angles θ1 and θ2 are smaller than 20°, the rigidity of that region becomes excessively high, the rigidity balance is lost, and it becomes difficult to manufacture the tire. It is preferable that the angle θ2 is greater than the angle θ1 by 10 to 20°. The region S more affects the vertical rigidity of the tire as compared with the region F. Therefore, if the angle θ2 is set greater than the angle θ1, it is possible to efficiently suppress the increase in the vertical rigidity of the tire. If the difference between the angles θ2 and θ1 exceeds 20°, the balance of rigidity is lost and durability is deteriorated.

The widthwise end of the belt layer 6 is a widthwise end of the inner layer 6a having greater widthwise size. The belt width is a width of the inner layer 6a having greater widthwise size, also. It is unnecessary that the belt width matches with the width of the tread portion Tr but in this embodiment, the inner layer 6a has substantially the same width as that of the tread portion Tr, and the outer layer 6b has a slightly smaller width than that of the inner layer 6a. A boundary between the regions F and S is line segments L1 to L3 which intersect with the carcass layer 5 at right angles as shown in FIG. 1.

The cords constituting the carcass layers 5a and 5b are respectively disposed such as to be inclined substantially symmetrically at angles θ3 and θ4 with respect to the tire circumferential direction PD in the vicinity of the tire equator CL and in the vicinity of the tire maximum width position PW. The angles θ3 and θ4 are greater than the angles θ1 and θ2 by 5° or more and are set 75° or more. This design prevents the vertical rigidity of the tire from increasing, jumping of the vehicle is suppressed and the running time can be shortened. That is, if the difference between the angles θ3 and θ4 and the angles θ1 and θ2 is less than 5°, or less than 75°, there is a tendency that the vertical rigidity of the tire is increased.

In this embodiment, the angle θ3 in the region from the line segment L1 to the tire equator CL is 90°, the angle θ4 in the region from the line segment L3 to the bead 1a is 90°. It is preferable that angles θ3 and θ4 are 80 to 90°, and the difference between the angles θ3 and θ4 and the angles θ1 and θ2 is 30° or less. If the difference between the angles θ3 and θ4 and the angles θ1 and θ2 exceeds 30°, the rigidity balance is lost, and durability is deteriorated.

In this embodiment, a reinforcing layer 7 is disposed from the bead portion 1 to the side portion. The reinforcing layer 7 extends from between the bead filler 1b and the folded back portion of the carcass layer 5 radially outward of the tire and reaches the tire maximum width position PW, and reaches the position of the widthwise end of the belt layer 6 in some cases. In the racing pneumatic tire, load at the time of cornering, driving and braking is greater as those of a pneumatic tire of a passenger vehicle, and requirement concerning riding comfort is smaller. Therefore, such a reinforcing layer 7 is disposed and the rigidity of the side portion is set higher.

If the reinforcing layer 7 is disposed and the rigidity of the side portion is set higher, not only the lateral rigidity and longitudinal rigidity of the tire but also the vertical rigidity is also enhanced, but according to the present invention, since it is possible to suppress the increase of the vertical rigidity of the tire as described above, this is especially useful as the racing pneumatic tire.

A preferable constituent material of the reinforcing layer 7 is steel. The reinforcing layer may also be made of organic fiber such as aramid. In such a case, the reinforcing layer can be folded back at the bead la and disposed such as to sandwich the bead filler 1b between the folded back portion and the main body portion.

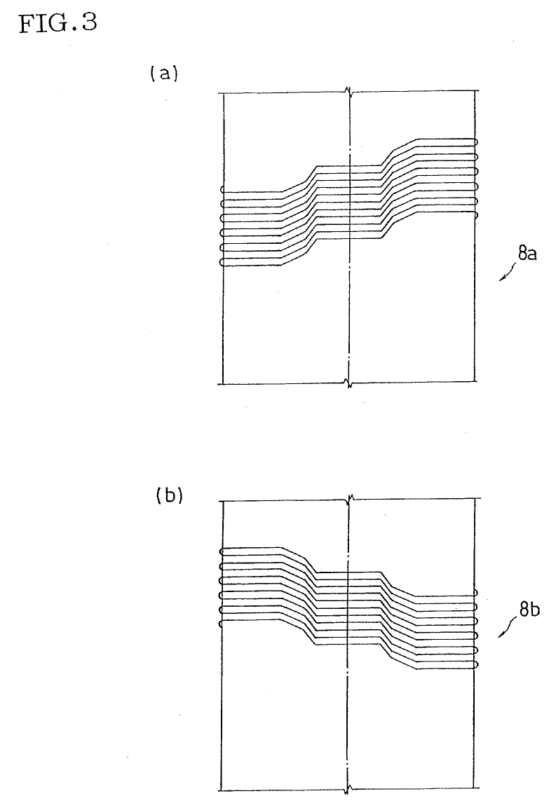

The racing pneumatic tire of the present invention can be manufactured by the same manufacturing method as that for a normal racing pneumatic tire except that carcass plies 8a and 8b whose cord angles are partially changed depending upon the position in the widthwise direction as shown in FIGS. 3. That is, it is possible to employ a manufacturing method having a step for laminating the carcass plies 8a and 8b on a forming drum, a forming tray and the like, and a step for expanding at least laminated carcass plies 8a and 8b into doughnut shape.

The two carcass plies 8a and 8b are cylindrically laminated such that the cords are disposed at symmetric angle with respect to the center line. After the bead 1a is disposed, a tube air bag is inserted, the air bag is shaped into a doughnut shape by internal pressure and then, the belt layer 6 is formed.

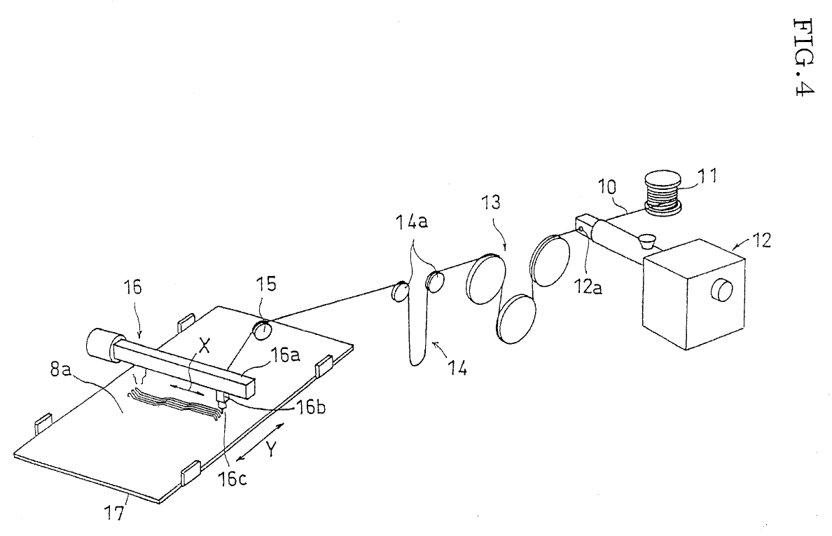

The outline of the manufacturing method of the carcass plies 8a and 8b shown in FIGS. 3 will be explained next. Using an apparatus as shown in FIG. 4, the rollers 13 pull a cord material 10, the cord material 10 is sent from a bobbin 11 and in this state, the cord material 10 is allowed to pass through a cap 12a of an extruding machine 12 for the coating rubber, thereby coating the cord material 10 with non-vulcanized rubber, and the cord coated with rubber is sent between the buffering rollers 14a of the buffer 14 and the cord sags. A tip end of the cord coated with rubber is pasted on a tray 17 in a desired path by a pasting roller 16c provided on a driving section 16b of a driving mechanism 16, and the cord is pulled out from the buffer 14 through a guide roller 15 by a length corresponding to the pasting amount. Control of the pasting path can be carried out by position control of movement of the tray 17 in the longitudinal direction (Y direction) and position control of movement of the driving section 16b which reciprocates (in X direction) a support section 16a of the driving mechanism 16. It is easy to paste the cord without cutting the cord. In this case, two pasting rollers 16c having parallel axes and the same height are used.

In order to obtain desired tire shape and desired cord angle at each portion, it is preferable to appropriately adjust the cord angle when the carcass plies 8a and 8b are manufactured. In the case of a bias tire, a relation between the cord angle in the ply state and the cord angle after the tire is shaped can be calculated by a known relation equation (an approximate expression) RdcosA =RcosAd. In this invention also, this relation equation can be used similarly, and if R is determined while using Ad as a variable, A can be obtained. Here, Rd represents a radius of a drum, Ad represents a cord angle on a drum with respect to the circumferential direction, R represents a radius corresponding to the position of cord after the tire is shaped, and A represents a cord angle with respect to the circumferential direction after the tire is shaped.

[Another Embodiment]

(1) The region F is 10% of the belt width from the widthwise end of the belt layer 6 toward the tire equator. The region F can effectively increase the lateral rigidity and longitudinal rigidity of the tire and thus, it is preferable that the region F is 15% of the belt width. Due to the same reason, it is preferable that the region S is 15% of the belt width from the widthwise end of the belt layer 6 toward the tire maximum width position PW along the carcass shape. In this case, it is preferable that the region S is 15% of the belt width in a range not exceeding 30 mm along the carcass shape in the cross section of the meridian. With this, it is possible to more effectively suppress the increase in vertical rigidity of the tire.

(2) In the above embodiment, there are two carcass layers 5. The present invention is not limited to this structure, and the number of the carcass layers 5 may be an even number such as four. In this case also, it is preferable that the pair of carcass layers are laminated such that the cords are inclined at substantially symmetric angles with respect to the tire equator CL, and the cords of each carcass layer laminated in the same direction are disposed in the same direction in each portion.

### EXAMPLE OF THE PRESENT INVENTION

An example tire which concretely shows the structure and effect of the present invention will be explained. Evaluation items of the example and the like were measured in the following manner.

(1) Vertical Rigidity

An air pressure was set to 120 kPa, displacement of a tire in the radial direction of the tire when a load of 2.16 kN corresponding to a load of an actual vehicle was applied was measured, and reciprocals of the measured value were indicated as indices. A conventional example was set to 100 in the evaluation. The greater the numeric value is, the greater the vertical rigidity is (poorer).

(2) Lateral Rigidity

In a state where a load of 2.16 kN was applied in the same manner, displacement of the tire in the widthwise direction when the load of 2.16 kN was applied in the tire widthwise direction was measured, and reciprocals of the measured value were indicated as indices. A conventional example was set to 100 in the evaluation. The greater the numeric value is, the greater the lateral rigidity is (more excellent).

(3) Longitudinal Rigidity

In a state where a load of 2.16 kN was applied in the same manner, displacement of the tire in the longitudinal direction when the load of 1.08 kN was applied in the tire longitudinal direction was measured, and reciprocals of the measured value were indicated as indices. A conventional example was set to 100 in the evaluation. The greater the numeric value is, the greater the longitudinal rigidity is (more excellent).

(4) Lap Time

The tire was mounted on the racing vehicle (formula car), and the vehicle was allowed to run on a circuit, and lap time at that time was measured. A conventional example was set to 100 as index in the evaluation. The smaller the numeric value is, the faster the lap time is (more excellent). In the running test on the circuit, if a difference of 0.3 seconds/one circuit is generated, it is determined that this is significant, and in the current evaluation, the index of 0.5 corresponds to 0.3 seconds/one circuit.

### CONVENTIONAL EXAMPLE

In the above-described embodiment, racing pneumatic tires (tire size: front wheel 175/55R13, rear wheel 215/50R13) in which the angles θ1 and θ2 were set to 90° were prepared as the conventional example. The carcass layer comprised two laminated carcass plies (polyester fiber, 1670dtex/2, the number of striking of 23/2.5 cm), and two belt plies (steel cord 2+1×0.27, the number of striking 15/2.5 cm, cord angle of 22°) were laminated.

### EXAMPLES OF THE INVENTION AND COMPARATIVE EXAMPLE

Racing pneumatic tires which were the same as those of the conventional example except that the angles θ1 and θ2 were set to the angles shown in Table 1 were prepared as examples of the present invention and a comparative example. The regions F and S were 15% of the belt width from the widthwise ends of the respective belt layers. Results of the evaluation are shown in Table 1.

TABLE 1

| | | Example | | | | | | | | |
|---|---|---|---|---|---|---|---|---|---|---|
| | Conven- | of the | Example | Example | Example | Example | Example | Example | Example | Compara- |
| | tional | inven- | of the | of the | of the | of the | of the | of the | of the | tive |
| | example | tion 1 | invention 2 | invention 3 | invention 4 | invention 5 | invention 6 | invention 7 | invention 8 | example |
| Angle θ1 | 90 | 80 | 60 | 60 | 60 | 40 | 40 | 40 | 40 | 35 |
| Angle θ2 | 90 | 90 | 70 | 80 | 90 | 50 | 60 | 70 | 40 | 40 |
| Vertical | 100 | 100 | 105 | 104 | 103 | 107 | 106 | 105 | 108 | 112 |
| rigidity | | | | | | | | | | |
| Lateral | 100 | 99 | 102 | 102 | 101 | 104 | 104 | 103 | 105 | 106 |
| rigidity | | | | | | | | | | |
| Longitudinal | 100 | 103 | 112 | 110 | 108 | 120 | 117 | 114 | 125 | 130 |
| rigidity | | | | | | | | | | |
| Rap time | 100 | 99.5 | 99.1 | 99.2 | 99.3 | 98.6 | 98.9 | 99 | 99.5 | 100 |

As shown in the results of Table 1, in the tires of the examples of the present invention, the lateral rigidity and the longitudinal rigidity are enhanced, and the running time is shortened, while the increase of the vertical rigidity of the tire is suppressed. In the example 8 of the invention, the vertical rigidity of the tire is relatively high and the shortening degree of the running time is small, but in the examples 5 and 6 of the invention, since the angle θ2 is greater than the angle θ1, the running time is shortened excellently. On the other hand, in the comparative example, the vertical rigidity of the tire is excessively high and thus, the running time is not shortened. As described above, according to the present invention, in the racing pneumatic tire, adhesion, cornering performance and traction performance can be secured and the running time can be shortened.

What is claimed is:

1. A racing pneumatic tire comprising at least two carcass layers for reinforcing between a pair of annular beads, and a belt layer disposed on an outer peripheral side of the carcass layer below a tread portion, wherein
the two carcass layers are laminated on each other such that cords are inclined substantially symmetrically with respect to a tire circumferential direction, an angle of the cords with respect to the tire circumferential direction in a first region of 10% of a belt width from a widthwise end of the belt layer toward a tire equator is 40 to 80°, and an angle of the cords with respect to the tire circumferential direction in the vicinity of the tire equator and in the vicinity of the maximum width position is greater than the angle in the first region by 5° and is 75° or greater.

2. The racing pneumatic tire according to claim 1, wherein the angle of the cords with respect to the tire circumferential direction in a second region of 10% of a belt width from the widthwise end of the belt layer toward the tire maximum width position is 40 to 80°, and the angle of the cords with respect to the tire circumferential direction in the vicinity of the tire equator and in the vicinity of the maximum width position is greater than the angle in the second region by 5° and is 75° or greater.

3. The racing pneumatic tire according to claim 2, wherein the angle of the cords with respect to the tire circumferential direction in the second region is greater than that in the first region by 10 to 20°.
